(19) United States
(12) Patent Application Publication
(10) Pub. No.: US 2025/0003444 A1
(43) Pub. Date: Jan. 2, 2025

(54) COMBINED SCREW AND RIVET

(71) Applicant: Snap-on Incorporated, Kenosha, WI (US)

(72) Inventors: Colten W. Burr, Kenosha, WI (US); Mark T. Gordon, Union Grove, WI (US); David T. Ross, Antioch, IL (US)

(73) Assignee: Snap-on Incorporated, Kenosha, WI (US)

(21) Appl. No.: 18/828,983

(22) Filed: Sep. 9, 2024

Related U.S. Application Data
(63) Continuation of application No. 15/978,419, filed on May 14, 2018.

(51) Int. Cl. F16B 39/02; B25B 13/46; B25B 23/00

(52) U.S. Cl. CPC F16B 39/025; B25B 13/462; B25B 23/0007

(57) ABSTRACT

Disclosed is a combination screw and rivet fastener that couples a cover plate to a ratchet head. The fastener is inserted into the ratchet head and then screwed into a hole of the cover plate. Thereafter, the tip of the fastener opposite the fastener head is deformed in a rivet operation.

### CROSS-REFERENCE TO RELATED APPLICATIONS

This application is a continuation of, and claims priority to, U.S. patent application Ser. No. 15/978,419, filed May 14, 2018, the contents of which are incorporated herein by reference in their entirety.

### TECHNICAL FIELD OF THE INVENTION

The present invention relates generally to fasteners. More particularly, the present invention relates to a combined screw and rivet to be used with, for example, a ratchet wrench cover plate.

### BACKGROUND OF THE INVENTION

Ratchet wrenches are commonly used to fasten fasteners to base materials or to other hardware such as a nut. Ratchet wrenches allow a user to rotate a wrench handle in a first rotational direction to apply torque, and to then rotate the wrench handle in a second rotational direction to return the wrench handle to its original position without applying reverse torque to the work piece. The process can then be repeated until the requisite amount of torque is applied to the work piece.

Ratchet wrenches and other tools typically include cover plates. In the ratchet wrench context, the cover plate encloses a ratchet head housing that includes ratchet components inside, for example, the ratchet gear. The cover plate is typically fastened to the ratchet head housing by a screw, as shown in, for example, FIGS. 5 and 6. As shown, a screw 500 can connect a ratchet head 505 to a cover plate 510. The screw 500 is typically inserted into an opening 515 in the ratchet head 505 and then screwed into a hole 520 in the cover plate 510. In doing so, the screw 500 connects the cover plate 510 to the ratchet head 505, but is susceptible to loosening or falling out, creating debris and opening the ratchet head 505.

### SUMMARY OF THE INVENTION

The present invention broadly comprise a combination screw and rivet fastener that couples a cover plate to a ratchet head. The fastener is first inserted into a clearance hole that may be void of threads, and the fastener is then screwed into an opening in a cover plate until the fastener head is substantially flush against the ratchet head. The tip of the fastener opposite the fastener head is then deformed in a riveting operation to more securely couple the cover plate to the ratchet head.

For example, in an embodiment, the present invention broadly comprises a ratchet wrench including a ratchet head having a clearance hole extending therethrough, a cover plate coupled to the ratchet head and enclosing contents within the ratchet head, the cover plate including an opening, and a fastener having a fastener head located at a first end, a tip located at a second end opposite the first end, a shaft extending between the fastener head and the tip, and threads disposed around the shaft. The fastener is coupled to the cover plate at the threads and the tip is deformed in a riveting operation.

Further disclosed is a method of assembling a ratchet wrench including providing a fastener having a fastener head located at a first end, a tip located at a second end opposite the first end, a shaft extending between the fastener head and the tip, and threads disposed around the shaft, inserting the fastener through a clearance hole of a ratchet head, coupling the fastener to an opening of a cover plate by screwing the fastener into the opening at the threads, and performing a riveting operation at the tip to secure the fastener to the cover plate and ratchet head.

### BRIEF DESCRIPTION OF DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a side view of a fastener according to at least some of the presently disclosed embodiments.

FIG. 2 is a side sectional view of a fastener located in a ratchet head and coupled to a cover plate with the tip of the fastener in the undeformed position according to at least some of the presently disclosed embodiments.

FIG. 3 is a side sectional view of a fastener located in a ratchet head and coupled to a cover plate with the tip of the fastener in the deformed position according to at least some of the presently disclosed embodiments.

FIG. 4 is a flow chart illustrating a method of assembling a ratchet head according to at least some of the presently disclosed embodiments.

FIG. 5 is an exploded view of a prior art fastener, ratchet head, and cover plate combination.

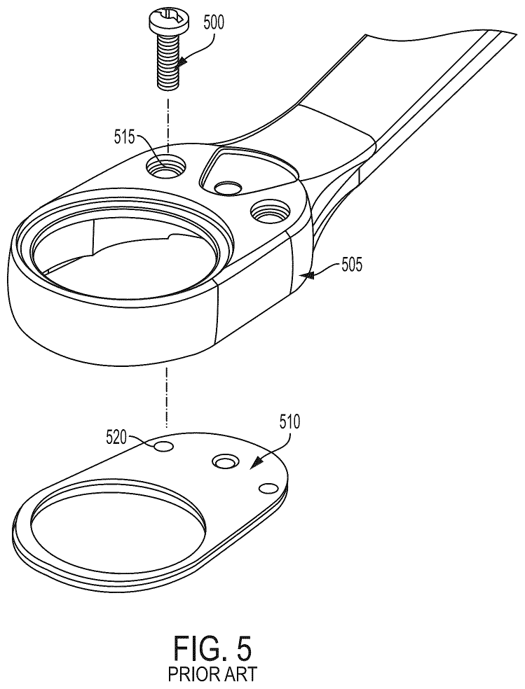

FIG. 6 is a side sectional view of the prior art fastener, ratchet head, and cover plate combination illustrated in FIG. 5.

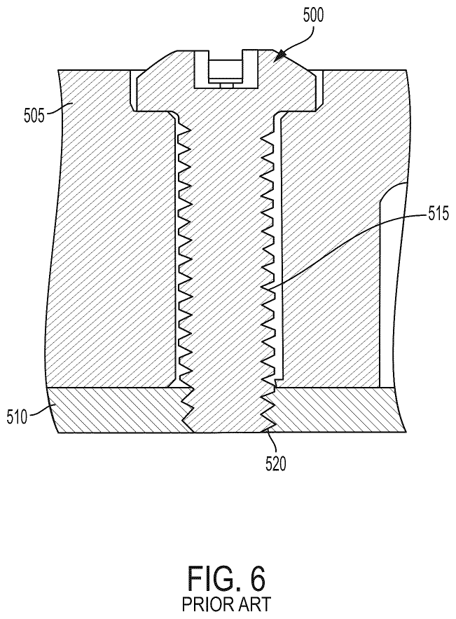

### DETAILED DESCRIPTION OF THE INVENTION

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

The present invention broadly comprises a combination screw and rivet fastener. In another embodiment, the present invention broadly comprises a method of securing a cover plate to a ratchet head using a combination screw and rivet fastener. The fastener can be inserted into the ratchet head and then screwed into an opening in a cover plate until the fastener head is substantially flush against the ratchet head surface. A riveting operation can then be performed on the tip of the fastener opposite the fastener head to more securely couple the cover plate to the ratchet head.

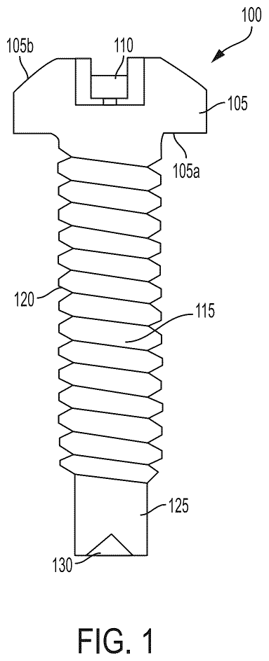

Referring to FIG. 1, a fastener 100 is shown with a fastener head 105 having a top side 105b and a bottom side 105a opposite the top side 105b. The fastener head 105 also includes a slot 110 located on the top side 105b for receiving a screwdriver or other tool so that the fastener 100 can be rotated and coupled to a cover plate, as described below in more detail. A shaft 115 can extend from the fastener head 105 and include threads 120. A tip 125 can extend from the shaft 115 at an end of the fastener 100 opposite the fastener head 105. A dimple 130 can be located on the end of the tip 125 to allow easier deformation of the tip 125 in a riveting operation, as described below in more detail.

As shown, the fastener head 105 can be a rounded screw head with a slot 110 for a slotted screwdriver. However, the present invention is not so limited and the fastener head 105 can instead be any shape or size, for example, a flat, oval, round, pan, button, hex, truss, hex washer, or fillister head, for example. The slot 110 is also not limited to a conventional slot and can instead be a Phillips head, straight slot, combination Phillips head and straight slot, hexagonal opening, or any other shape or size slot that allows a tool to grip the slot and rotate the fastener 100.

The shaft 115 acts as the structural backbone of the fastener and can be any size or shape that provides such structural support. The threads 120 on the shaft 115 can likewise be any type of threads, for example right-hand or left-hand threads, without departing from the spirit and scope of the present invention.

The tip 125 and dimple 130 are provided on an end of the fastener 100 opposite the fastener head 105. The tip 125 and dimple 130 are structured and manufactured to allow for a deformation in the tip 125 in a riveting operation, and the tip 125 and dimple 130 can therefore be any size or shape, and the fastener 100 can be any material, that allows such an operation.

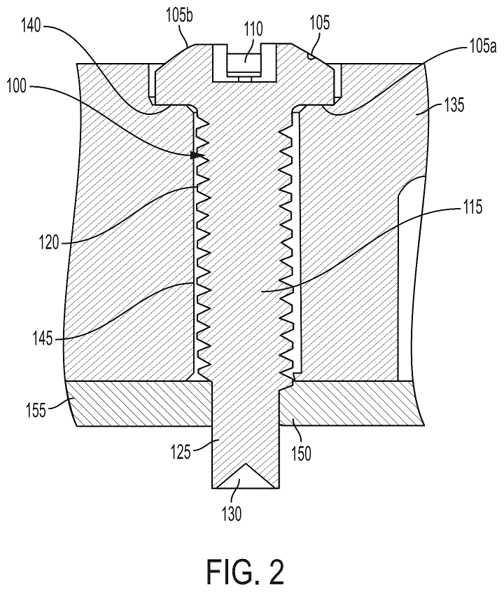

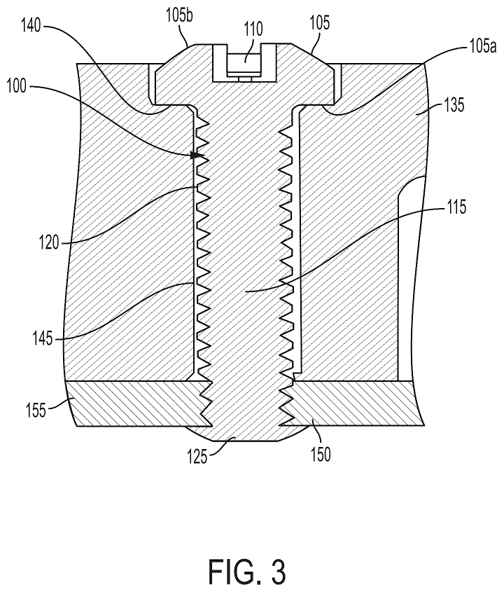

Referring to FIGS. 2 and 3, the fastener 100 can first be inserted into a ratchet head 135 of a ratchet wrench by placing the fastener 100 in a counterbore 140 of the ratchet head 135. The shaft 115 can then extend through a clearance hole 145 in the ratchet head 135 and screw into an opening 150 on a cover plate 155, as shown. For example, and without limitation, the fastener 100 can be inserted through the clearance hole 145 until the bottom side 105a of the fastener head 105 abuts the bottom surface of the counterbore 140 or, if there is no counterbore 140, a top surface of the ratchet head 135. More generally, in some embodiments, the fastener 100 can be inserted until the fastener head 105 is flush with the surface upon which it rests.

Once the fastener 100 is inserted into the ratchet head 135, the threads 120 of the fastener 100 can then be screwed into the cover plate 155. Here, the threads 120 can be screwed into the opening 150 of the cover plate until, for example, the fastener head 105 is flush with the surface upon which it rests, as shown in FIG. 2. Thereafter, the tip 125 of the fastener 100 can be deformed, for example in a riveting operation, as shown in FIG. 3.

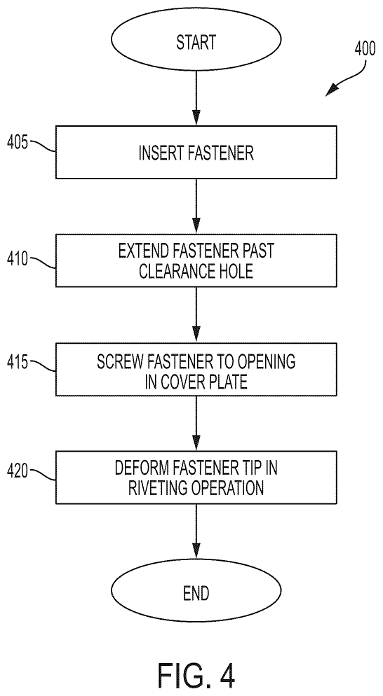

FIG. 4 is a flow chart illustrating a method of assembling a ratchet wrench according to at least some of the presently disclosed embodiments. As shown, the process 400 begins and proceeds to step 405, where the fastener 100 is inserted into the ratchet head 105. The fastener 100 is then extended past the clearance hole 145 in step 410, and screwed to an opening 150 in the cover plate 155 in step 415. A riveting operation is then performed in step 420 to deform the fastener 100, for example the tip 125 thereof, and secure the fastener 100 against the ratchet head 105 as shown in FIG. 3. The process 400 then ends.

As discussed herein, the fastener 100 can be implemented in a ratchet wrench within a ratchet head 105, but the present invention is not so limited. For example, the fastener 100 can also be implemented in any other tool or any other application other than a tool.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A tool having a tool head, the tool comprising:
a clearance hole extending through the tool head, wherein the clearance hole is void of threads;
a cover plate adapted to be coupled to the tool to enclose contents within the tool head, the cover plate including an opening axially aligned with the clearance hole; and
a combination screw and rivet fastener having a fastener head located at a first end, a non-threaded tip located at a second end opposite the first end and that includes a dimple adapted to control a location of axial and radial deformation of the non-threaded tip that occurs in response to a riveting operation, and a shaft extending between the fastener head and the non-threaded tip, and threads disposed around at least a portion of the shaft, wherein the non-threaded tip has a tip diameter smaller than a shaft diameter of the portion of the shaft that includes the threads,
wherein the combination screw and rivet fastener extends through the clearance hole and is treadably engaged only with the opening in the cover plate with the threads, and wherein the riveting operation causes the non-threaded tip to be permanently deformed radially to widen circumferentially at the location to form a mushroomed head to rivetably couple the cover plate to the tool head.

2. The tool of claim 1, wherein the tool head includes a counterbore that receives the fastener head.

3. The tool of claim 2, wherein the fastener head is disposed flush against a surface of the counterbore.

4. The tool of claim 1, wherein the fastener head is disposed flush against a surface of the tool head.

5. A method of assembling a tool comprising:
providing a combination screw and rivet fastener having a fastener head located at a first end, a non-threaded tip located at a second end opposite the first end and that includes a dimple adapted to control a location of axial and radial deformation of the non-threaded tip caused by a riveting operation, a shaft extending between the fastener head and the non-threaded tip, and threads disposed around at least a portion of the shaft, wherein the non-threaded tip has a tip diameter smaller than a shaft diameter of the portion of the shaft that includes the threads;
inserting the combination screw and rivet fastener through a clearance hole extending through a tool head of the tool, the clearance hole is void of threads;
threadably coupling the threads on the portion of the shaft of the combination screw and rivet fastener only to an opening disposed in a cover plate; and
performing a riveting operation on the non-threaded tip to permanently deform the non-threaded tip radially to widen circumferentially at the location to form a mushroomed head to cause the combination screw and rivet fastener to rivetably couple the cover plate to the tool head.

6. The method of claim 5, wherein the step of inserting the combination screw and rivet fastener through a clearance hole includes inserting the combination screw and rivet fastener until the fastener head is flush against a surface of the tool head.

7. The method of claim 5, wherein the step of inserting the combination screw and rivet fastener through a clearance hole includes inserting the combination screw and rivet fastener until the fastener head is flush against a surface of a counterbore defined within the tool head.

8. A ratchet wrench having a ratchet head and a ratchet gear disposed in the ratchet head, the ratchet wrench comprising:
a clearance hole extending through the ratchet head, wherein the clearance hole is void of threads;
a cover plate adapted to be coupled to the ratchet head to enclose the ratchet gear within the ratchet head, the cover plate including an opening that is adapted to be axially aligned with the clearance hole; and
a combination screw and rivet fastener having a fastener head located at a first end, a non-threaded tip located at a second end opposite the first end and that includes a dimple adapted to control a location of axial and radial deformation of the non-threaded tip caused by a riveting operation, a shaft extending between the fastener head and the non-threaded tip, and threads disposed around at least a portion of the shaft, wherein the non-threaded tip has a tip diameter smaller than a shaft diameter of the portion of the shaft that includes the threads,
wherein the combination screw and rivet fastener extends through the clearance hole and the opening and is threadably coupled only to the cover plate with the threads on the portion of the shaft, and wherein the non-threaded tip is permanently deformed radially to widen circumferentially at the location during the riveting operation to form a mushroomed head to cause the combination screw and rivet fastener to rivetably couple the cover plate to the ratchet head.
